(19) United States
(12) Patent Application Publication
(10) Pub. No.: US 2022/0390230 A1
(43) Pub. Date: Dec. 8, 2022

(54) METHOD FOR GENERATING SPEECH PACKAGE, AND ELECTRONIC DEVICE

(71) Applicant: BEIJING BAIDU NETCOM SCIENCE TECHNOLOGY CO., LTD., Beijing (CN)

(72) Inventors: Bo PENG, Beijing (CN); Chao LI, Beijing (CN); Cong GAO, Beijing (CN); Zhanjie GAO, Beijing (CN); Yunfeng LI, Beijing (CN)

(21) Appl. No.: 17/883,395

(22) Filed: Aug. 8, 2022

(30) Foreign Application Priority Data
Aug. 11, 2021 (CN) 202110921313.0

(51) Int. Cl. G01C 3/02; G10L 25/60; G10L 15/30; G10L 15/22

(52) U.S. Cl. CPC G01C 3/02; G10L 25/60; G10L 15/30; G10L 15/22

(57) ABSTRACT

A method for generating a speech package, an electronic device and a storage medium The method includes: determining a number of texts to be displayed and a speech recording condition based on a type of a recording mode selection control in response to the recording mode selection control being triggered; acquiring speech data with an amount matched with the number based on the speech recording condition; sending the speech data to a server; and acquiring a speech package generated by the server using the speech data.

### CROSS-REFERENCE TO RELATED APPLICATION

This application claims priority to Chinese Patent Application No. 202110921313.0 filed on Aug. 11, 2021, the disclosure of which is hereby incorporated by reference in its entirety.

### TECHNICAL FIELD

The disclosure relates to a field of computer technologies, particularly to a field of artificial intelligence (AI) technologies such as speech technology and natural language processing (NLP), and specifically to a method for generating a speech package, an electronic device and a storage medium.

### BACKGROUND

With the development of computer technology, speech playing functions for different speakers are provided in computer application products using a speech synthesis technology. For example, in a map product, a speech package may be generated based on audio data recorded by a user, and the speech package of the user may be used to perform navigation speech playing during speech navigation.

Therefore, it is an urgent problem to be solved how to improve the diversity of ways for generating a speech package.

### SUMMARY

According to one aspect of the disclosure, a method for generating a speech package is provided, and includes: determining a number of texts to be displayed and a speech recording condition based on a type of a recording mode selection control in response to the recording mode selection control being triggered; acquiring speech data with an amount matched with the number based on the speech recording condition; sending the speech data to a server; and acquiring a speech package generated by the server using the speech data.

According to another aspect of the disclosure, an electronic device is provided, and includes: at least one processor; and a memory communicatively connected to the at least one processor. The memory is stored with instructions executable by the at least one processor, the instructions are performed by the at least one processor, to cause the at least one processor to perform the method as described in the above embodiments.

According to another aspect of the disclosure, a non-transitory computer readable storage medium stored with computer instructions is provided, the computer instructions are configured to perform the method as described in the above embodiments by the computer.

According to another aspect of the disclosure, a computer program product including a computer program is provided, the computer program is configured to implement the method as described in the above embodiments when performed by a processor.

It should be understood that, the content described in this part is not intended to identify key or important features of embodiments of the disclosure, nor intended to limit the scope of the disclosure. Other features of the disclosure will be easy to understand through the following specification.

### BRIEF DESCRIPTION OF THE DRAWINGS

The drawings are intended to better understand the solution, and do not constitute a limitation to the disclosure.

FIG. 1 is a flowchart of a method for generating a speech package according to an embodiment of the disclosure;

FIG. 2 is a flowchart of a method for generating a speech package according to an embodiment of the disclosure;

FIG. 3 is a schematic diagram of a recording mode selection interface according to an embodiment of the disclosure;

FIG. 4 is a schematic diagram of a generation process of a speech package according to an embodiment of the disclosure;

FIG. 5 is a block diagram of an apparatus for generating a speech package according to an embodiment of the disclosure;

FIG. 6 is a schematic diagram of an electronic device configured to implement a method for generating a speech package according to an embodiment of the disclosure.

### DETAILED DESCRIPTION

The exemplary embodiments of the present disclosure are described as below with reference to the accompanying drawings, which include various details of embodiments of the present disclosure to facilitate understanding, and should be considered as merely exemplary. Therefore, those skilled in the art should realize that various changes and modifications may be made to the embodiments described herein without departing from the scope and spirit of the present disclosure. Similarly, for clarity and conciseness, descriptions of well-known functions and structures are omitted in the following descriptions.

A method and an apparatus for generating a speech package, an electronic device and a storage medium according to embodiments of the disclosure are described with reference to accompanying drawings.

Artificial intelligence (AI) is a subject that learns simulating certain thinking processes and intelligent behaviors (such as learning, reasoning, thinking, planning, etc.) of human beings using a computer, which covers hardware-level technologies and software-level technologies. AI hardware technologies generally include technologies such as sensors, dedicated AI chips, cloud computing, distributed storage, big data processing, etc.; AI software technologies include computer vision technology, speech recognition technology, natural language processing (NLP) technology, deep learning (DL), big data processing technology, knowledge graph technology, etc.

Speech technology refers to an automatic speech recognition technology and a speech synthesis technology in key technologies in the field of computer.

NLP is an important direction in the fields of computer science and artificial intelligence. The research contents of NLP include but not limited to: text classification, information extraction, automatic abstract, intelligent question answering, topic recommendation, machine translation, subject term recognition, knowledge base construction, deep text representation, named entity recognition, text generation, text analysis (morphology, syntax, grammar, etc.), speech recognition and synthesis.

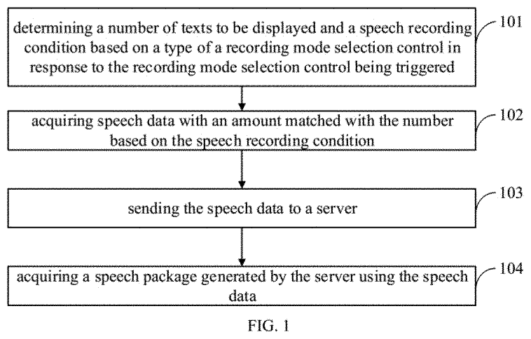

FIG. 1 is a flowchart of a method for generating a speech package according to an embodiment of the disclosure.

The method for generating a speech package according to an embodiment of the disclosure may be performed by an apparatus for generating a speech package according to an embodiment of the disclosure, and the apparatus may be configured in an electronic device to generate speech packages based on speech data recorded in different recording modes, which improves the diversity of ways for generating a speech package.

As illustrated in FIG. 1, the method for generating a speech package includes following steps.

At block 101, the number of texts to be displayed and a speech recording condition are determined based on a type of a recording mode selection control in response to acquiring that the recording mode selection control is triggered.

In some embodiments of the disclosure, some applications on the electronic device may provide functions for generating a speech package, for example, a map application, a travel application, etc. An application may contain a plurality of recording mode selection controls, and a user may select any of the plurality of recording mode selection controls according to actual demands. After a user opens an application and triggers a corresponding control, the electronic device may display a recording mode selection control, or the user may search a required recording mode in an application.

In some embodiments of the disclosure, the number of the texts to be displayed and the speech recording condition may vary with the recording mode. When the user triggers a recording mode selection mode displayed on the electronic device, in response to acquiring that the recording mode selection control is triggered, the electronic device may determine the number of texts to be displayed and the speech recording condition corresponding to the recording mode selection control based on the type of the recording mode selection control and correspondence between (numbers of texts to be displayed and speech recording conditions) and respective types.

The text to be displayed refers to a text that may be read by the user when the user records speech data, and the speech recording condition may refer to a condition that may be satisfied by the recorded speech data in a recording mode.

At block 102, speech data with an amount matched with the number is acquired based on the speech recording condition.

After the number of the texts to be displayed and the speech recording condition are determined, the speech data with the amount matched with the number of the texts to be displayed may be acquired based on the speech recording condition. For example, the number of the texts to be displayed is 9, then 9 pieces of speech data corresponding to the texts to be displayed may be acquired based on the speech recording condition.

The acquisition, storage, and application of the user speech information involved in the technical solution of the disclosure comply with relevant laws and regulations, and do not violate public order and good customs.

At block 103, the speech data is sent to a server.

When the speech data with the amount matched with the number of the texts to be displayed is acquired, the speech data acquired may be sent to the server, and a data packet may be generated by the server using the speech data recorded by the user.

During generating the speech package, the server may use the speech data to train a model. When training of the model is finished, the speech package may be generated based on acoustic features learned by the model.

At block 104, a speech package generated by the server using the speech data is acquired.

The server may send the speech package generated based on the speech data recorded by the user to the electronic device, so that the electronic device may acquire the speech package generated by the server using the speech data.

For example, when the user triggers a certain recording mode selection control, the electronic device may determine that the number of texts to be displayed corresponding to the selected recording mode is 9 and all of 9 pieces of speech data recorded under a corresponding speech recording condition satisfies satisfy the quality requirement, then 9 pieces of speech data recorded by the user are acquired based on the texts to be displayed on an interface under the speech recording condition, and the 9 pieces of speech data recorded are sent to the server.

The server may train a speech synthesis model based on the 9 pieces of speech data to generate the speech package. Each of the 9 pieces of speech data may be sliced during training to acquire a plurality of speech slices of each piece of speech data. The acquired speech slices are input to a style label network to acquire a style label vector corresponding to each speech slice. The style label vector of each speech slice is input to an acoustic model, so that the acoustic model may learn an acoustic feature of the user, thus, the speech package may be generated based on the learned acoustic feature.

The electronic device may provide a speech playing function with the same pronunciation as the user based on the speech package after acquiring the speech package. For example, in a map product, a speech package may be generated based on audio data recorded by a user, and the speech package of the user may be used to perform speech playing during speech navigation. For another example, in a travel product, scenic spots may be introduced based on the speech package generated by the speech data recorded by the user.

With the embodiment of the disclosure, the number of texts to be displayed and the speech recording condition are determined based on the type of the recording mode selection control in response to acquiring that the recording mode selection control is triggered, the speech data with the amount matched with the number is acquired based on the speech recording condition, the speech data is sent to the server, and the speech package generated by the server using the speech data is acquired. Therefore, speech packages may be generated based on speech data recorded in different recording modes, which improves the diversity of ways for generating speech packages.

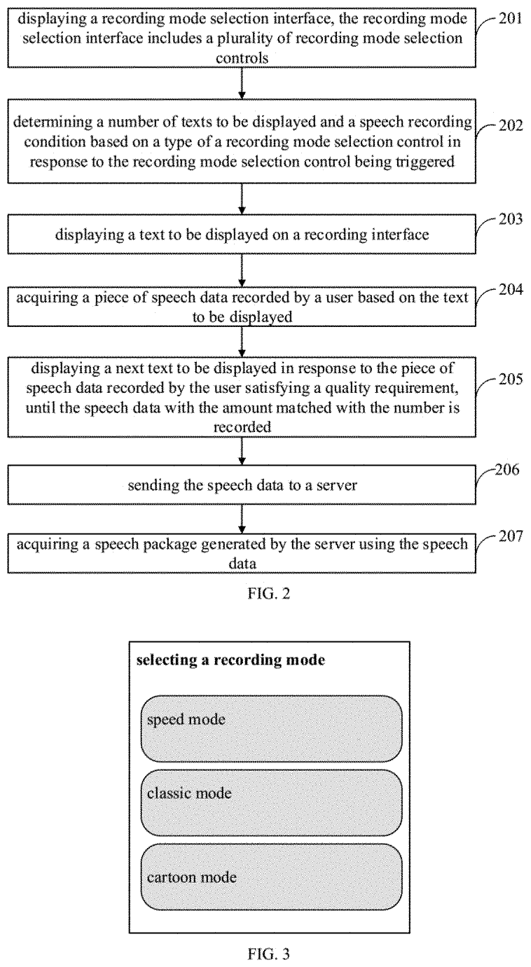

In order to improve the quality of the speech package, in one embodiment of the disclosure, each piece of speech data acquired may satisfy the quality requirement, to acquire a speech package using the speech data satisfying the quality requirement. Description is made below with reference to FIG. 2. FIG. 2 is a flowchart of a method for generating a speech package according to an embodiment of the disclosure.

As illustrated in FIG. 2, the method for generating a speech package includes following steps.

At block 201, a recording mode selection interface is displayed, the recording mode selection interface includes a plurality of recording mode selection controls.

In some embodiments of the disclosure, some applications on an electronic device may provide functions for generating a speech package. When a user opens an application and triggers a corresponding control, the electronic device may display the recording mode selection interface. The recording mode selection interface may include a plurality of recording mode selection controls.

FIG. 3 is a schematic diagram of a recording mode selection interface according to an embodiment of the disclosure. As illustrated in FIG. 3, the recording mode selection interface may include a selection control for a speed mode, a selection control for a classic mode, a selection control for a cartoon mode, etc.

In some embodiments of the disclosure, a plurality of recording mode selection controls are provided on the recording mode selection interface, to facilitate the user to select a desired recording mode.

At block 202, the number of texts to be displayed and a speech recording condition are determined based on a type of a recording mode selection control in response to acquiring that the recording mode selection control is triggered.

In some embodiments of the disclosure, the numbers of the texts to be displayed and the speech recording conditions corresponding to different recording modes may be different. For example, as illustrated in FIG. 3, the number of texts to be displayed corresponding to the speed mode may be a1-a2, and a corresponding speech recording condition may be that all the recorded speech data satisfies the quality requirement. The number of texts to be displayed corresponding to the classic mode may be a3-a4, and a corresponding speech recording condition may be that more than 90% speech data in the recorded speech data satisfies the quality requirement. The number of texts to be displayed corresponding to the cartoon mode may be a5-a6, and a corresponding speech recording condition may be that more than 80% speech data in the recorded speech data satisfies the quality requirement. The number of the texts to be displayed corresponding to the speed mode may be less than that corresponding to the classic mode, and the number of the texts to be displayed corresponding to the classic mode may be less than that corresponding to the cartoon mode.

In some embodiments of the disclosure, when the user triggers any one of the recording mode selection modes displayed on the recording mode selection interface, the electronic device may determine the number of texts to be displayed and the speech recording condition corresponding to the triggered recording mode selection control based on the type of the triggered recording mode selection control, and the correspondence between the numbers of texts to be displayed and the speech recording conditions and respective types in response to acquiring that the recording mode selection control is triggered.

For example, the number of the texts to be displayed corresponding to the speed mode as illustrated in FIG. 3 is 9, the number of the texts to be displayed corresponding to the classic mode is 20. When the user triggers the first recording mode selection control on the selection interface as illustrated in FIG. 3, the electronic device may determine that the number of the texts to be displayed is 9 in response to the type of the recording mode selection control being the speed type, and the corresponding speech recording condition may be that all the recorded 9 pieces of speech data satisfy the quality requirement. For another example, when the user triggers the classic mode selection control, it may be determined that the number of the texts to be displayed is 20, and the corresponding speech recording condition may be that more than 17 of the recorded 20 pieces of speech data satisfy the quality requirement.

It should be noted that, the numbers of texts to be displayed and the speech recording conditions under different recording modes are merely examples and may be configured based on the actual requirement, which are not limited in the disclosure.

At block 203, a text to be displayed is displayed on a recording interface.

In some embodiments of the disclosure, each recording mode may corresponds to texts to be displayed. After a selected recording mode is determined, texts to be displayed corresponding to the selected recording mode may be acquired from a server, and one of the texts to be displayed may be displayed on the recording interface.

Or, when a text to be displayed is displayed, an audio corresponding to the text to be displayed may also be played to facilitate the user to follow based on the audio.

At block 204, a piece of speech data recorded by a user based on the text to be displayed is acquired.

In some embodiments of the disclosure, the user may read the text to be displayed, and the electronic device may record the piece of speech data of the user, thereby acquiring the piece of speech data recorded by the user based on the text to be displayed.

At block 205, a next text to be displayed is displayed in response to the piece of speech data recorded by the user satisfying a quality requirement, until the speech data with the amount matched with the number is recorded.

In order to improve the quality of the speech data recorded by the user, in the disclosure, when the speech data recorded by the user is acquired, speech quality detection may be performed on the acquired speech data. The next text to be displayed is displayed in response to the speech data recorded by the user satisfying the quality requirement, so that the user can continue to record speech data based on the next text to be displayed until the speech data with the amount matched with the number of the texts to be displayed is recorded.

That is, the next text to be displayed is displayed in response to the piece of speech data currently recorded satisfying the quantity requirement, so that each piece of speech data recorded by the user satisfies the quality requirement.

In some embodiments of the disclosure, when speech quality detection is performed on speech data, it may be determined whether volume of the speech data satisfies a volume requirement, whether text content corresponding to the speech data is consistent with the text to be displayed, whether pauses in the speech data satisfy a pause requirement, whether pronunciation of each word in the speech data satisfies a pronunciation requirement, whether speech speed of the speech data satisfies a speech speed requirement, whether a signal-to-noise ratio of the speech data is not less than a preset threshold, and whether a likelihood value of the speech data is greater than a preset score, etc.

Correspondingly, satisfying the quality requirement may include at least one of: the volume of the speech data satisfies the volume requirement, the text content corresponding to the speech data is consistent with the text to be displayed, the pauses in the speech data satisfy the pause requirement, the pronunciation of each word in the speech data satisfies the pronunciation requirement, the speech speed of the speech data satisfies the speech speed requirement, the signal-to-noise ratio of the speech data is not less than the preset threshold, and the likelihood value of the speech data is greater than the preset score, etc. Therefore, the next piece of speech data is recorded in response to the speech data currently recorded satisfying the quality requirement, thereby ensuring that each piece of speech data recorded satisfies the quality requirement.

At block 206, the speech data is sent to a server.

In some embodiments of the disclosure, block 206 is similar to block 103, which is not repeated here.

At block 207, a speech package generated by the server using the speech data is acquired.

In some embodiments of the disclosure, the server may send the speech package generated based on the speech data recorded by the user to the electronic device, so that the electronic device may acquire the speech package generated using the speech data by the server.

For example, in the recording mode selection interface illustrated in FIG. 3, the number of the texts to be displayed corresponding to the speed mode is 9, the number of the texts to be displayed corresponding to the classic mode is 20. When the user triggers the speed mode selection control, and it is determined that the number of texts to be displayed is 9 and all of 9 pieces of speech data recorded under a corresponding speech recording condition satisfies the quality requirement, then 9 pieces of speech data recorded by the user are acquired based on the texts to be displayed on the interface under the speech recording condition, and the 9 pieces of speech data recorded are sent to the server.

The server may train a speech synthesis model based on the 9 pieces of speech data to generate the speech package. Each of the 9 pieces of speech data may be sliced during training to acquire a plurality of speech slices of each speech data. The acquired speech slices are input to a style label network to acquire a style label vector corresponding to each speech slice. The style label vector of each speech slice is input to an acoustic model, so that the acoustic model may learn an acoustic feature of the user, thus, the speech package may be generated based on the learned acoustic feature. In this way, the user may merely record 9 sentences to generate a personalized speech package. Compared with 20 sentences in a classic mode, the number of sentences recorded by the user is reduced, and the recording time of the user and a waiting duration after recording are reduced.

With the embodiment of the disclosure, when the speech data with the amount matched with the number of the texts to be displayed is acquired based on the speech recording condition, the text to be displayed may be displayed on the recording interface to acquire speech data recorded by the user based on the text to be displayed, and the next text to be displayed is displayed in response to the currently recorded piece of speech data satisfying the quality requirement, until the speech data with the amount matched with the number is recorded. Therefore, the next piece of speech data is recorded under the condition that the currently recorded piece of speech data satisfies the quality requirement, thereby ensuring that each piece of speech data recorded satisfies the quality requirement, and the speech package is generated using the pieces of speech data, which improves the quality of the speech package.

In an embodiment of the disclosure, recording adjustment prompt information may be determined based on a detection result of the piece of speech data recorded by the user in response to the piece of speech data recorded by the user not satisfying the quality requirement, and the recording adjustment prompt information may be displayed, so that the user may adjust a recording way based on the recording adjustment prompt information and re-records speech data based on the text to be displayed.

When the re-recorded speech data is acquired, the speech quality detection is performed on the re-recorded speech data. Next text data may be displayed in response to the re-recorded speech data satisfying the quality requirement, until the speech data with the amount matched with the number of the texts to be displayed is recorded.

Recording adjustment prompt information may be determined and displayed based on a detection result of the re-recorded speech data in response to the re-recorded speech data not satisfying the quality requirement, so that the user can adjust a recording way based on the recording adjustment prompt information and re-records speech data based on the text to be displayed currently displayed, until the re-recorded speech data satisfies the quality requirement. Therefore, the recording adjustment prompt information is determined and displayed in a case where the speech data of a certain text recorded by the user does not satisfy the quality requirement, until the speech data satisfying the quality requirement is acquired.

For example, a second text is currently displayed, and speech data of the second text recorded by the user is acquired. It is detected that the volume of speech data is less than a preset volume range. Based on the detection result, it may be determined that the recording adjustment reminding information is “please increase volume”. The user adjusts volume based on the recording adjustment reminding information and re-reads the second text to acquire speech data re-recorded by the user, and speech quality detection is performed on the re-recorded speech data to determine whether the re-recorded speech data satisfies the quality requirement.

With the embodiment of the disclosure, in response to the speech data not satisfying the quality requirement, the recording adjustment prompt information may be determined based on the detection result of the speech data, and the recording adjustment prompt information may be displayed, to acquire speech data re-recorded by the user based on the text to be displayed. Therefore, in a case that the recorded speech data does not satisfy the quality requirement, the recording adjustment prompt information is displayed to the user, to make the user re-record speech data based on the recording adjustment prompt information, thereby reducing the time for the user to record speech data In the case of ensuring that the recorded speech data satisfies the quality requirement.

In practical applications, when the environment where the electronic device is currently located is noisy, audio data recorded in the environment may contain noise, resulting in poor quality of audio data.

Based on this, in one embodiment of the disclosure, before the speech data with an amount matched with the number of the texts to be displayed is acquired based on the speech recording condition, environment audio data of current environment may be acquired, and decibels of the environment audio data may be acquired. In response to the decibels of the environment audio data being less than a decibel threshold, it may be determined that the current environment is relatively quiet, and the current environment satisfies a preset environmental condition, thus speech data may be recorded in the current environment. Therefore, it may be ensured that the speech data is recorded in a condition where the current environment satisfies the preset environment condition, which reduces noise contained in the speech data recorded by the user and improves the quality of speech data.

Environmental prompt information, such as “the noise in the current environment is relatively large, please record in a quiet environment”, may be determined in response to the decibels of the environment audio data being greater than or equal to the decibel threshold. Therefore, the user may move to a quiet environment based on the environmental prompt information, or may stop playing music if playing the music, so as to record speech data in recording environment satisfying the requirement.

In practical applications, when the user and the electronic device are too close, the sound of blowing on the microphone may be recorded, resulting in a large amount of harsh noise in the synthesis effect, and when a distance between the user and the electronic device is too long, the volume of the recorded speech data is relatively low.

Based on this, in one embodiment of the disclosure, before the speech data with an amount matched with the number of the texts to be displayed is acquired based on the speech recording condition, the distance between the user and the electronic device may be further acquired to determine whether the distance satisfies a requirement.

In some embodiments of the disclosure, before the speech data is recorded, a ranging instruction may be sent to a ranging apparatus on the electronic device, so that the ranging apparatus measures the distance between the user and the electronic device based on the ranging instruction, and the distance between the user and the electronic device measured by the measuring apparatus is acquired.

For example, the ranging instruction is sent to an infrared apparatus in the electronic device, and the infrared apparatus may measure the distance between the user and the electronic device by emitting infrared rays.

After the distance between the user and the electronic device is acquired, it is determined whether the distance is within a preset distance range. In response to the distance between the user and the electronic device out of the preset distance range, distance adjustment information is generated and displayed, so that the user adjusts the distance between the user and the electronic device based on the distance adjustment prompt information, until the distance between the user and the electronic device is within the preset distance range.

For example, the preset distance range is 10 to 20 cm, and when the distance between the user and a mobile phone is 8 cm, the adjustment prompt information “the distance is too short, please adjust the distance between the user and the mobile phone” may be generated, and the user may adjust the distance between the user and the mobile phone based on the prompt information until the distance is within the range of 10 to 20 cm.

In response to the distance between the user and the electronic device being within the preset distance range, the speech data with an amount matched with the number of the texts to be displayed may be acquired based on the speech recording condition. The recorded speech data may be sent to the server, and a speech package may be acquired from the server.

With the embodiment of the disclosure, before the speech data with the amount matched with the number of the texts to be displayed is acquired based on the speech recording condition, it is determined whether the distance between the user and the electronic device satisfies the requirement. The distance adjustment prompt information is generated in response to the distance not satisfying the requirement, so that the user can adjust the distance between the user and the electronic device based on the distance adjustment prompt information, thereby ensuring that the speech data is recorded in a condition that the distance between the user and the electronic device satisfies the requirement, which improves the quality of the speech data.

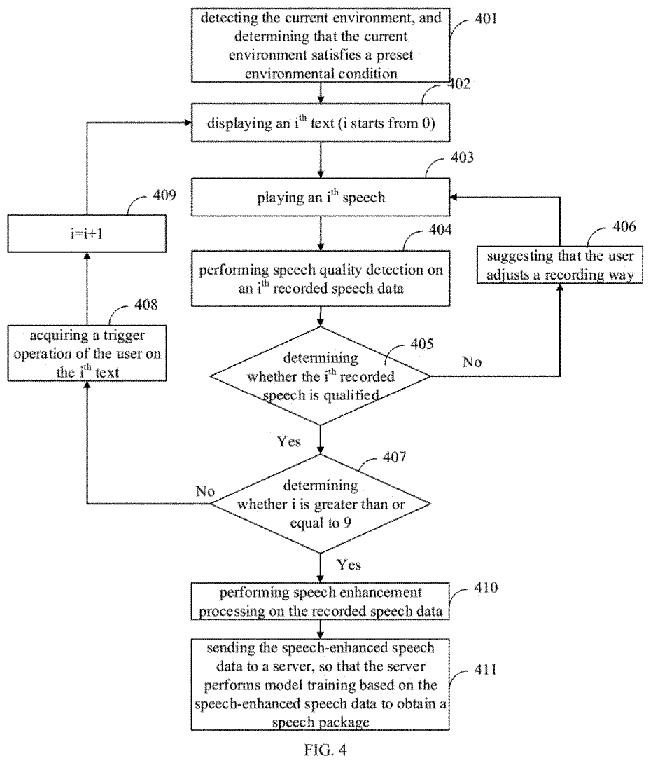

In order to further describe the above embodiments, descriptions are made with reference to FIG. 4. FIG. 4 is a schematic diagram of a generation process of a speech package according to an embodiment of the disclosure.

For example, in the generation process of a speech package in FIG. 4, the recording mode is the speed mode as illustrated in FIG. 3. The user triggers a speed mode selection control in the recording mode selection interface. It is determined that the number of the texts to be displayed is 9 based on the control type, and the speech recording condition is that all the 9 pieces of speech data satisfy a quality requirement.

As illustrated in FIG. 4, the generation process of the speech package includes the following.

At block 401, the current environment is detected, and it is determined that the current environment satisfies a preset environmental condition.

At block 402, an i^{th} text is displayed (i starts from 0).

At block 403, an i^{th} speech is played so that the user follows it. The i^{th} speech is a speech corresponding to the i^{th} text.

At block 404, speech quality detection is performed on an i^{th} recorded speech data.

At block 405, it is determined whether the i^{th} recorded speech data is qualified. If no, actions at block 406 is performed; if yes, actions at block 407 is performed.

At block 406, it is suggested that the user adjusts a recording way.

At block 407, it is determined whether i is greater than or equal to 9. If yes, actions at block 410 is performed; if no, actions at block 408 is performed.

At block 408, a trigger operation of the user on the i^{th} text is acquired.

At block 409, i=i+1.

At block 410, speech enhancement processing is performed on the recorded speech data.

In some embodiments of the disclosure, the speech enhancement processing may be performed on the recorded each speech data, to reduce noise in speech data and improve the quality of speech data.

At block 411, the speech-enhanced speech data is sent to a server, so that the server performs model training based on the speech-enhanced speech data to obtain a speech package.

With the method for generating a speech package as illustrated in FIG. 4, the speech package can be generated by recording 9 pieces of speech data by the user, and compared with using 20 sentences, the sentence number recorded by the user is reduced, with relatively short recording time and simple operations, and the waiting time after the recording of the user is relatively short.

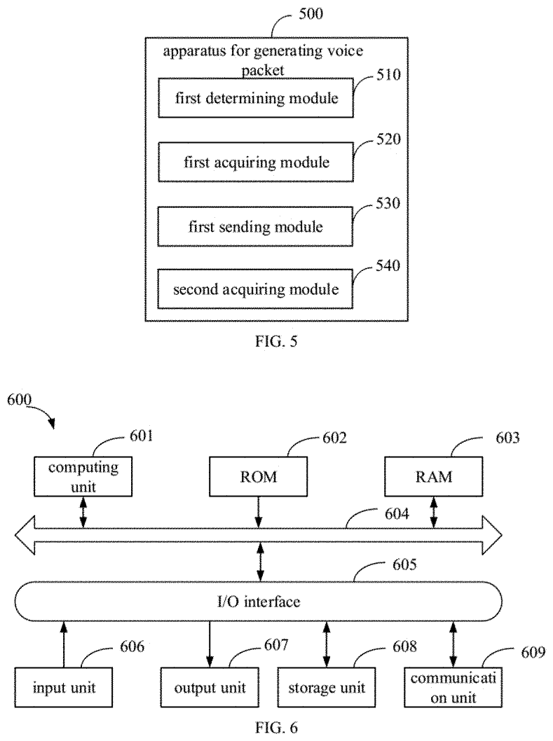

In order to achieve the above embodiments, an apparatus for generating a speech package is further provided in the embodiment of the disclosure. FIG. 5 is a block diagram of a structure of an apparatus for generating a speech package according to an embodiment of the disclosure.

As illustrated in FIG. 5, the apparatus 500 for generating a speech package includes a first determining module 510, a first acquiring module 520, a first sending module 530 and a second acquiring module 540.

The first determining module 510 is configured to determine a number of texts to be displayed and a speech recording condition based on a type of a recording mode selection control in response to the recording mode selection control being triggered.

The first acquiring module 520 is configured to acquire speech data with an amount matched with the number based on the speech recording condition.

The first sending module 530 is configured to send the speech data to a server.

The second acquiring module 540 is configured to acquire a speech package generated by the server using the speech data.

In a possible implementation of the embodiment of the disclosure, the first acquiring module 520 is configured to: display a text to be displayed on a recording interface; acquire a piece of speech data recorded by a user based on the text to be displayed; and display a next text to be displayed in response to the piece of speech data recorded by the user satisfying a quality requirement, until the speech data with the amount matched with the quantity is recorded.

In a possible implementation of the embodiment of the disclosure, the apparatus may further include a second determining module and a first display module.

The second determining module is configured to determine recording adjustment prompt information based on a detection result of the piece of speech data recorded by the user in response to the piece of speech data recorded by the user not satisfying the quality requirement.

The first display module is configured to display the recording adjustment prompt information.

The first acquiring module 520 is further configured to acquire speech data re-recorded by the user based on the text to be displayed.

In a possible implementation of the embodiment of the disclosure, satisfying the quality requirement comprises at least one of: volume of the speech data satisfying a volume requirement, text content corresponding to the speech data being consistent with the text to be displayed, pause in the speech data satisfying a pause requirement, pronunciation of each word in the speech data satisfying a pronunciation requirement, speech speed of the speech data satisfying a speech speed requirement, and a signal-to-noise ratio of the speech data being not less than a preset threshold.

In a possible implementation of the embodiment of the disclosure, the apparatus may further include a third acquiring module and a third determining module.

The third acquiring module is configured to acquire environment audio data of current environment.

The third determining module is configured to determine that the current environment satisfies a preset environmental condition in response to decibels of the environment audio data being less than a decibel threshold.

In a possible implementation of the embodiment of the disclosure, the apparatus may further include a second sending module, a fourth acquiring module, a generating module and a second display module.

The second sending module is configured to send a ranging instruction to a ranging apparatus on an electronic device.

The fourth acquiring module is configured to acquire a distance between a user and the electronic device measured by the ranging apparatus based on the ranging instruction.

The generating module is configured to generate distance adjustment prompt information in response to the distance being out of a preset distance range.

The second display module is configured to display the distance adjustment prompt information until the distance is within the preset distance range.

In a possible implementation of the embodiment of the disclosure, the apparatus may further include a third display module.

The third display module is configured to display a recording mode selection interface, the recording mode selection interface includes a plurality of recording mode selection controls.

It needs to be noted that the foregoing explanation of the method embodiment for generating a speech package is also suitable for the apparatus for generating the speech package in the embodiment, which will not be repeated here.

With the embodiment of the disclosure, the number of texts to be displayed and the speech recording condition are determined based on the type of the recording mode selection control in response to acquiring that the recording mode selection control is triggered, the speech data with the amount matched with the number is acquired based on the speech recording condition, the speech data is sent to the server, and the speech package generated by the server using the speech data is acquired. Therefore, speech packages may be generated based on speech data recorded in different recording modes, which improves the diversity of ways for generating speech packages.

According to the embodiments of the disclosure, an electronic device, a readable storage medium and a computer program product are further provided in the disclosure.

FIG. 6 illustrates a schematic diagram of an example electronic device 600 configured to implement the embodiment of the disclosure. An electronic device is intended to represent various types of digital computers, such as laptop computers, desktop computers, workstations, personal digital assistants, servers, blade servers, mainframe computers, and other suitable computers. An electronic device may also represent various types of mobile apparatuses, such as personal digital assistants, cellular phones, smart phones, wearable devices, and other similar computing devices. The components shown herein, their connections and relations, and their functions are merely examples, and are not intended to limit the implementation of the disclosure described and/or required herein.

As illustrated in FIG. 6, a device 600 includes a computing unit 601, which may be configured to execute various appropriate actions and processes according to a computer program stored in a read-only memory (ROM) 602 or loaded from a storage unit 608 to a random access memory (RAM) 603. In a RAM 603, various programs and data required by an operation of a device 600 may be further stored. A computing unit 601, a ROM 602 and a RAM 603 may be connected with each other by a bus 604. An input/output (I/O) interface 605 is also connected to a bus 604.

A plurality of components in the device 600 are connected to an I/O interface 605, and includes: an input unit 606, for example, a keyboard, a mouse, etc.; an output unit 607, for example various types of displays, speakers; a storage unit 608, for example a magnetic disk, an optical disk; and a communication unit 609, for example, a network card, a modem, a wireless transceiver. The communication unit 609 allows a device 600 to exchange information/data through a computer network such as internet and/or various types of telecommunication networks and other devices.

The computing unit 601 may be various types of general and/or dedicated processing components with processing and computing ability. Some examples of a computing unit 601 include but not limited to a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. The computing unit 601 performs various methods and processings as described above, for example, a method for generating a speech package. For example, in some embodiments, a method for generating a speech package may be further achieved as a computer software program, which is physically contained in a machine readable medium, such as a storage unit 608. In some embodiments, a part or all of the computer program may be loaded and/or installed on the device 600 via a ROM 602 and/or a communication unit 609. When the computer program is loaded on a RAM 603 and performed by a computing unit 601, one or more blocks in the above method for generating a speech package may be performed. Alternatively, in other embodiments, a computing unit 601 may be configured to perform a method for generating a speech package in other appropriate ways (for example, by virtue of a firmware).

Various implementation modes of systems and technologies described herein may be implemented in a digital electronic circuit system, an integrated circuit system, a field programmable gate array (FPGA), a dedicated application specific integrated circuit (ASIC), an application specific standard product (ASSP), a system on a chip (SoC), a complex programmable logic device (CPLD), a computer hardware, a firmware, a software, and/or combinations thereof. The various implementation modes may include: being implemented in one or more computer programs, and the one or more computer programs may be executed and/or interpreted on a programmable system including at least one programmable processor, and the programmable processor may be a dedicated or a general-purpose programmable processor that may receive data and instructions from a storage system, at least one input apparatus, and at least one output apparatus, and transmit the data and instructions to the storage system, the at least one input apparatus, and the at least one output apparatus.

A computer code configured to execute a method in the present disclosure may be written with one or any combination of a plurality of programming languages. The programming languages may be provided to a processor or a controller of a general purpose computer, a dedicated computer, or other apparatuses for programmable data processing so that the function/operation specified in the flowchart and/or block diagram may be performed when the program code is executed by the processor or controller. A computer code may be performed completely or partly on the machine, performed partly on the machine as an independent software package and performed partly or completely on the remote machine or server.

In the context of the disclosure, a machine-readable medium may be a tangible medium that may contain or store a program intended for use in or in conjunction with an instruction execution system, apparatus, or device. A machine readable medium may be a machine readable signal medium or a machine readable storage medium. A machine readable storage medium may include but not limited to an electronic, magnetic, optical, electromagnetic, infrared, or semiconductor system, apparatus or device, or any appropriate combination thereof. A more specific example of a machine readable storage medium includes an electronic connector with one or more cables, a portable computer disk, a hardware, a RAM, a ROM, an electrically programmable read-only memory (an EPROM) or a flash memory, an optical fiber device, and a compact disc read-only memory (CD-ROM), an optical storage device, a magnetic storage device, or any appropriate combination thereof.

In order to provide interaction with the user, the systems and technologies described here may be implemented on a computer, and the computer has: a display apparatus for displaying information to the user (for example, a CRT (cathode ray tube) or a LCD (liquid crystal display) monitor); and a keyboard and a pointing apparatus (for example, a mouse or a trackball) through which the user may provide input to the computer. Other types of apparatuses may be further configured to provide interaction with the user; for example, the feedback provided to the user may be any form of sensory feedback (for example, visual feedback, auditory feedback, or tactile feedback); and input from the user may be received in any form (including an acoustic input, a voice input, or a tactile input).

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation mode of the system and technology described herein), or a computing system including any combination of such back-end components, middleware components or front-end components. The system components may be connected to each other through any form or medium of digital data communication (for example, a communication network). The examples of a communication network include a Local Area Network (LAN), a Wide Area Network (WAN), an internet and a blockchain network.

The computer system may include a client and a server. The client and server are generally far away from each other and generally interact with each other through a communication network. The relationship between the client and the server is generated by computer programs running on the corresponding computer and having a client-server relationship with each other. A server may be a cloud server, also known as a cloud computing server or a cloud host, is a host product in a cloud computing service system, to solve the shortcomings of large management difficulty and weak business expansibility existed in the traditional physical host and Virtual Private Server (VPS) service. A server further may be a server with a distributed system, or a server in combination with a blockchain.

According to the embodiment of the disclosure, a computer program product is further provided. The instructions in the computer program product are configured to perform a method for generating a speech package as described when performed by a processor.

It should be understood that, various forms of procedures shown above may be configured to reorder, add or delete blocks. For example, blocks described in the disclosure may be performed in parallel, sequentially, or in a different order, as long as the desired result of the technical solution disclosed in the present disclosure may be achieved, which will not be limited herein.

The above specific implementations do not constitute a limitation on the protection scope of the disclosure. Those skilled in the art should understand that various modifications, combinations, sub-combinations and substitutions may be made according to design requirements and other factors. Any modification, equivalent replacement, improvement, etc., made within the spirit and principle of embodiments of the present disclosure shall be included within the protection scope of the present disclosure.

What is claimed is:

1. A method for generating a speech package, comprising:
determining a number of texts to be displayed and a speech recording condition based on a type of a recording mode selection control in response to the recording mode selection control being triggered;
acquiring speech data with an amount matched with the number based on the speech recording condition;
sending the speech data to a server; and
acquiring a speech package generated by the server using the speech data.

2. The method of claim 1, wherein acquiring the speech data with an amount matched with the number based on the speech recording condition comprises:
displaying a text to be displayed on a recording interface;
acquiring a piece of speech data recorded by a user based on the text to be displayed; and
displaying a next text to be displayed in response to the piece of speech data recorded by the user satisfying a quality requirement, until the speech data with the amount matched with the number is recorded.

3. The method of claim 2, further comprising:
determining recording adjustment prompt information based on a detection result of the piece of speech data recorded by the user in response to the piece of speech data recorded by the user not satisfying the quality requirement;
displaying the recording adjustment prompt information; and
acquiring speech data re-recorded by the user based on the text to be displayed.

4. The method of claim 2, wherein satisfying the quality requirement comprises at least one of: volume of the speech data satisfying a volume requirement, text content corresponding to the speech data being consistent with the text to be displayed, pause in the speech data satisfying a pause requirement, pronunciation of each word in the speech data satisfying a pronunciation requirement, speech speed of the speech data satisfying a speech speed requirement, a signal-to-noise ratio of the speech data being not less than a preset threshold, and a likelihood value of the speech data being greater than a preset score.

5. The method of claim 1, further comprising:
acquiring environment audio data of current environment; and
determining that the current environment satisfies a preset environmental condition in response to decibels of the environment audio data being less than a decibel threshold.

6. The method of claim 1, further comprising:
sending a ranging instruction to a ranging apparatus on an electronic device;
acquiring a distance between a user and the electronic device measured by the ranging apparatus based on the ranging instruction;
generating distance adjustment prompt information in response to the distance being out of a preset distance range; and
displaying the distance adjustment prompt information until the distance is within the preset distance range.

7. The method of claim 1, further comprising:
displaying a recording mode selection interface, wherein the recording mode selection interface comprises a plurality of recording mode selection controls.

8. An electronic device, comprising:
at least one processor; and
a memory communicatively connected to the at least one processor; wherein,
the memory is stored with instructions executable by the at least one processor, when the instructions are performed by the at least one processor, the at least one processor is caused to perform a method for generating a speech package, the method comprising:
determining a number of texts to be displayed and a speech recording condition based on a type of a recording mode selection control in response to the recording mode selection control being triggered;
acquiring speech data with an amount matched with the number based on the speech recording condition;
sending the speech data to a server; and
acquiring a speech package generated by the server using the speech data.

9. The electronic device of claim 8, wherein acquiring the speech data with an amount matched with the number based on the speech recording condition comprises:
displaying a text to be displayed on a recording interface;
acquiring a piece of speech data recorded by a user based on the text to be displayed; and
displaying a next text to be displayed in response to the piece of speech data recorded by the user satisfying a quality requirement, until the speech data with the amount matched with the number is recorded.

10. The electronic device of claim 9, wherein the method further comprises:
determining recording adjustment prompt information based on a detection result of the piece of speech data recorded by the user in response to the piece of speech data recorded by the user not satisfying the quality requirement;
displaying the recording adjustment prompt information; and
acquiring speech data re-recorded by the user based on the text to be displayed.

11. The electronic device of claim 9, wherein satisfying the quality requirement comprises at least one of: volume of the speech data satisfying a volume requirement, text content corresponding to the speech data being consistent with the text to be displayed, pause in the speech data satisfying a pause requirement, pronunciation of each word in the speech data satisfying a pronunciation requirement, speech speed of the speech data satisfying a speech speed requirement, a signal-to-noise ratio of the speech data being not less than a preset threshold, and a likelihood value of the speech data being greater than a preset score.

12. The electronic device of claim 8, wherein the method further comprises:
acquiring environment audio data of current environment; and
determining that the current environment satisfies a preset environmental condition in response to decibels of the environment audio data being less than a decibel threshold.

13. The electronic device of claim 8, wherein the method further comprises:
sending a ranging instruction to a ranging apparatus on an electronic device;
acquiring a distance between a user and the electronic device measured by the ranging apparatus based on the ranging instruction;
generating distance adjustment prompt information in response to the distance being out of a preset distance range; and
displaying the distance adjustment prompt information until the distance is within the preset distance range.

14. The electronic device of claim 8, wherein the method further comprises:
displaying a recording mode selection interface, wherein the recording mode selection interface comprises a plurality of recording mode selection controls.

15. A non-transitory computer readable storage medium stored with computer instructions, wherein, the computer instructions are configured to cause a computer to perform a method for generating a speech package, the method comprising:
determining a number of texts to be displayed and a speech recording condition based on a type of a recording mode selection control in response to the recording mode selection control being triggered;
acquiring speech data with an amount matched with the number based on the speech recording condition;
sending the speech data to a server; and
acquiring a speech package generated by the server using the speech data.

16. The non-transitory computer readable storage medium of claim 15, wherein acquiring the speech data with an amount matched with the number based on the speech recording condition comprises:
displaying a text to be displayed on a recording interface;
acquiring a piece of speech data recorded by a user based on the text to be displayed; and
displaying a next text to be displayed in response to the piece of speech data recorded by the user satisfying a quality requirement, until the speech data with the amount matched with the number is recorded.

17. The non-transitory computer readable storage medium of claim 16, wherein the method further comprises:
determining recording adjustment prompt information based on a detection result of the piece of speech data recorded by the user in response to the piece of speech data recorded by the user not satisfying the quality requirement;
displaying the recording adjustment prompt information; and
acquiring speech data re-recorded by the user based on the text to be displayed.

18. The non-transitory computer readable storage medium of claim 16, wherein satisfying the quality requirement comprises at least one of: volume of the speech data satisfying a volume requirement, text content corresponding to the speech data being consistent with the text to be displayed, pause in the speech data satisfying a pause requirement, pronunciation of each word in the speech data satisfying a pronunciation requirement, speech speed of the speech data satisfying a speech speed requirement, a signal-to-noise ratio of the speech data being not less than a preset threshold, and a likelihood value of the speech data being greater than a preset score.

19. The non-transitory computer readable storage medium of claim 15, wherein the method further comprises:
acquiring environment audio data of current environment; and
determining that the current environment satisfies a preset environmental condition in response to decibels of the environment audio data being less than a decibel threshold.

20. The non-transitory computer readable storage medium of claim 15, wherein the method further comprises:
sending a ranging instruction to a ranging apparatus on an electronic device;
acquiring a distance between a user and the electronic device measured by the ranging apparatus based on the ranging instruction;
generating distance adjustment prompt information in response to the distance being out of a preset distance range; and
displaying the distance adjustment prompt information until the distance is within the preset distance range.
